(19) United States
(12) Patent Application Publication
(10) Pub. No.: US 2013/0265493 A1
(43) Pub. Date: Oct. 10, 2013

(54) IMAGE PROCESSING UNIT, IMAGE PROCESSING METHOD, DISPLAY AND ELECTRONIC APPARATUS

(71) Applicant: SONY CORPORATION, Tokyo (JP)

(72) Inventors: NORIYOSHI TAKAHOTA, Kanagawa (JP); EIJI KATO, Kanagawa (JP); SHINROU TOMITA, Fukuoka (JP); SOUICHIROU KUMAGAI, Fukuoka (JP)

(73) Assignee: Sony Corporation, Tokyo (JP)

(21) Appl. No.: 13/854,670

(22) Filed: Apr. 1, 2013

(30) Foreign Application Priority Data
Apr. 4, 2012 (JP) 2012-085529

(51) Int. Cl. H04N 5/14

(52) U.S. Cl. CPC H04N 5/14
USPC 348/571

(57) ABSTRACT

There are provided an image processing unit, an image processing method, a display, and an electronic apparatus that are capable of enhancing image quality. The image processing unit includes: a region acquiring section determining a region shape of a picture region, based on a predetermined number of frame pictures of a series of frame pictures; and an image processing section performing predetermined image processing based on the region shape.

### BACKGROUND

The present disclosure relates to an image processing unit and an image processing method that perform image processing on a picture signal, and to a display and an electronic apparatus that are provided with such an image processing unit.

In recent years, various kinds of displays such as a liquid crystal display, a plasma display, and an organic EL display have been developed focusing on image quality and power consumption, and according to the characteristics thereof, the displays are applied to various electronic apparatuses such as a mobile phone and a personal digital assistant, in addition to stationary display. In addition, there is a display displaying a picture by projecting the picture onto a screen, such as a projection type display (a projector). Typically, these displays are each provided with an image processing circuit (an image processing unit) that performs predetermined processing based on an picture signal to enhance image quality. As such an image processing circuit, for example, there is a circuit acquiring, from a picture signal, a maximum value, a minimum value, an average luminance level, and the like (hereinafter, also referred to as a feature amount) of luminance information, and performing processing based on the feature amount.

Various pictures are input to such an image processing circuit. Specifically, for example, a picture having an aspect ratio different from an aspect ratio of a display screen is input, or a picture subjected to keystone correction that allows the picture to be displayed by a projection type display is input. In such cases, a region on which black color is displayed (no picture region) is generated in the periphery of a region on which an original picture is displayed (picture region), and thus, the image processing circuit needs to acquire a feature amount in the picture region on which an original picture is displayed, except for the region on which black color is displayed. For example, in Japanese Unexamined Patent Application Publication No. 2005-346032, a liquid crystal display is disclosed in which an average luminance level is detected in a predetermined region arranged at the middle or the like of a picture, and emission luminance of a backlight is modulated based on the average luminance level. In addition, for example, in Japanese Unexamined Patent Application Publication No. 2007-140483, a liquid crystal display is disclosed in which a picture region of a predetermined shape such as a letter-box shape is detected, and emission luminance of a backlight is modulated based on the average luminance level in the picture region.

### SUMMARY

In a display, high image quality is expected to be realized, and in an image processing unit used in such a display, further improvement of image quality is desired.

Accordingly, it is desirable to provide an image processing unit, an image processing method, a display, and an electronic apparatus that are capable of enhancing image quality.

According to an embodiment of the disclosure, there is provided an image processing unit including: a region acquiring section determining a region shape of a picture region, based on a predetermined number of frame pictures of a series of frame pictures; and an image processing section performing predetermined image processing based on the region shape.

According to an embodiment of the disclosure, there is provided an image processing method including: determining a region shape of a picture region, based on a predetermined number of frame pictures of a series of frame pictures; and performing predetermined image processing based on the region shape.

According to an embodiment of the disclosure, there is provided a display including: a region acquiring section determining a region shape of a picture region, based on a predetermined number of frame pictures of a series of frame pictures; an image processing section performing predetermined image processing based on the region shape; and a display section displaying a picture subjected to the predetermined image processing.

According to an embodiment of the disclosure, there is provided an electronic apparatus provided with an image processing unit and a control section controlling operation by using the image processing unit. The image processing unit includes: a region acquiring section determines a region shape of a picture region, based on a predetermined number of frame pictures of a series of frame pictures; and an image processing section performing predetermined image processing based on the region shape. Examples of such an electronic apparatus include a projector, a television, a digital camera, a personal computer, a video camera, and a mobile terminal device such as a mobile phone.

In the image processing unit, the image processing method, the display, and the electronic apparatus according to the embodiments of the disclosure, the predetermined image processing is performed based on the region shape of the picture region in the series of frame pictures. At this time, the region shape of the picture region is determined from the predetermined number of frame pictures of the series of frame pictures.

According to the image processing unit, the image processing method, the display, and the electronic apparatus of the embodiments of the disclosure, the region shape of the picture region is determined, and thus, image quality is enhanced.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a configuration example of a projector according to embodiments of the disclosure.

FIGS. 2A to 2C are explanatory diagrams illustrating an example of keystone correction.

FIGS. 3A and 3B are explanatory diagrams illustrating an example of arithmetic processing in a keystone correction section illustrated in FIG. 1.

FIG. 4 is a timing waveform chart illustrating input signals of a picture processing section illustrated in FIG. 1.

FIG. 5 is an explanatory diagram illustrating an operation example of a luminance information acquiring section and a control section illustrated in FIG. 1.

FIG. 6 is a block diagram illustrating a configuration example of a picture region acquiring section according to a first embodiment of the disclosure.

FIG. 7 is an explanatory diagram illustrating an operation example of the picture processing section illustrated in FIG. 1.

FIG. 8 is a schematic diagram illustrating an operation example of the picture region acquiring section according to the first embodiment.

FIG. 9 is a timing waveform chart illustrating another operation example of the picture region acquiring section according to the first embodiment.

FIGS. 10A to 10C are explanatory diagrams illustrating operation example of a luminance information acquiring section and a control section according to a modification of the first embodiment.

FIG. 11 is an explanatory diagram illustrating another operation example of the luminance information acquiring section and the control section according to the modification of the first embodiment.

FIGS. 12A and 12B are explanatory diagrams illustrating an operation example of a picture processing section according to the modification of the first embodiment.

FIG. 13 is a block diagram illustrating a configuration example of a picture region acquiring section according to a second embodiment of the disclosure.

FIG. 14 is a schematic diagram illustrating an operation example of the picture region acquiring section according to the second embodiment.

FIG. 15 is a schematic diagram illustrating an operation example of a picture region acquiring section according to a modification of the second embodiment.

FIG. 16 is an explanatory diagram illustrating an operation example of a luminance information acquiring section and a control section according to a third embodiment of the disclosure.

FIG. 17 is a block diagram illustrating a configuration example of a picture region acquiring section according to the third embodiment.

FIG. 18 is a schematic diagram illustrating an operation example of the picture region acquiring section according to the third embodiment.

FIG. 19 is a block diagram illustrating a configuration example of a picture region acquiring section according to a fourth embodiment of the disclosure.

FIG. 20 is a schematic diagram illustrating an operation example of the picture region acquiring section according to the fourth embodiment.

FIG. 21 is a perspective view illustrating an appearance configuration of a television to which the picture processing section of any of the embodiments is applied.

FIG. 22 is a block diagram illustrating a configuration example of a projector according to a modification.

FIG. 23 is a block diagram illustrating a configuration example of a picture processing section according to a modification.

### DETAILED DESCRIPTION

Hereinafter, preferred embodiments of the disclosure will be described in detail with reference to drawings. Note that the description thereof will be given in the following order.
1. First Embodiment
2. Second Embodiment
3. Third Embodiment
4. Fourth Embodiment
5. Application Examples

### 1. FIRST EMBODIMENT

### CONFIGURATION EXAMPLE

### OVERALL CONFIGURATION EXAMPLE

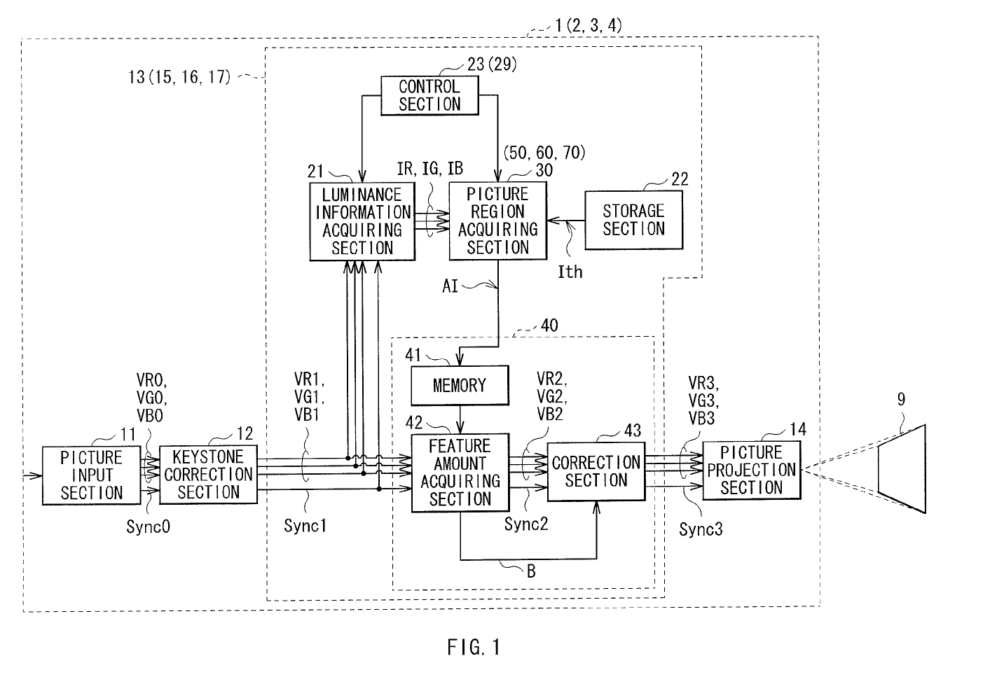

FIG. 1 illustrates a configuration example of a projector according to a first embodiment. A projector 1 is a projection type display projecting a picture on a screen 9 to display the picture. Note that the image processing unit and the image processing method according to the embodiments of the disclosure are embodied by the first embodiment, and thus are described together.

The projector 1 includes a picture input section 11, a keystone correction section 12, a picture processing section 13, and a picture projection section 14.

The picture input section 11 is an interface receiving a picture signal from an external apparatus such as a personal computer (PC). The picture input section 11 supplies the received picture signal to the keystone correction section 12, as picture signals VR0, VG0, and VB0 and a synchronization signal Sync0 synchronized with the picture signals VR0, VG0, and VB0.

The keystone correction section 12 performs arithmetic processing of keystone correction based on the picture signals supplied from the picture input section 11, to prevent a picture displayed on the screen 9 from being distorted into, for example, a trapezoidal shape.

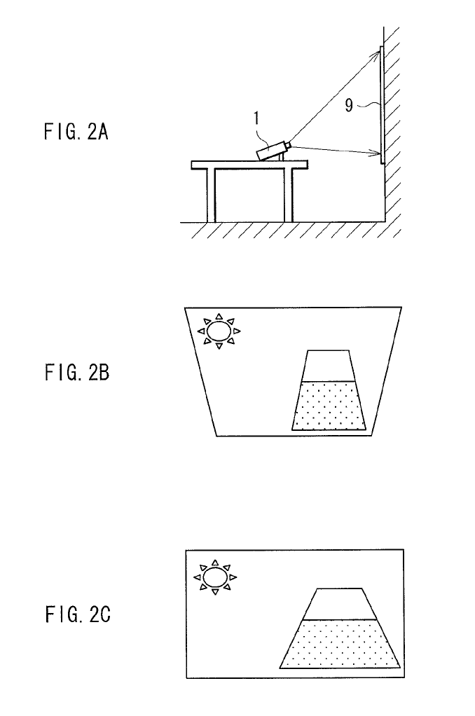

FIGS. 2A to 2C illustrate an example of an effect of the keystone correction, where FIG. 2A illustrates a location of the projector 1, FIG. 2B illustrates a picture displayed on the screen 9 when the keystone correction is not performed, and FIG. 2C illustrates a picture displayed on the screen 9 when the keystone correction is performed.

For example, in the case where the projector 1 is disposed on a table as illustrated in FIG. 2A, when a picture is projected as it is without being corrected, the displayed picture may be distorted into a trapezoidal shape as illustrated in FIG. 2B. Specifically, for example, the displayed picture is expanded in a horizontal direction toward upper side as illustrated in FIG. 2B because a distance between the projector 1 and the screen 9 is increased toward upper side as illustrated in FIG. 2A. On the other hand, the displayed picture is shrunk in the horizontal direction toward lower side as illustrated in FIG. 2B because the distance between the projector 1 and the screen 9 is decreased toward lower side as illustrated in FIG. 2A. In other words, the trapezoidal distortion is caused by relative positional relationship between the projector 1 and the screen 9 as illustrated in FIG. 2A. The keystone correction section 12 corrects the picture in advance so as to suppress such distortion of the picture displayed on the screen 9, namely, such that a rectangular original picture as illustrated in FIG. 2C is displayed on the screen 9.

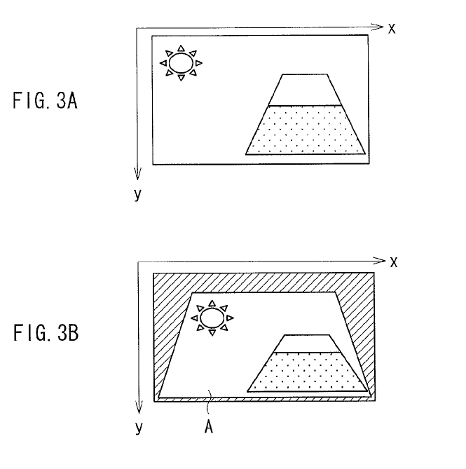

FIGS. 3A and 3B illustrate an example of the arithmetic processing by the keystone correction section 12, where FIG. 3A illustrates a picture input to the keystone correction section 12, and FIG. 3B illustrates a picture output from the keystone correction section 12.

The keystone correction section 12 performs the arithmetic processing of the keystone correction on the picture illustrated in FIG. 3A to generate the picture illustrated in FIG. 3B. To be more specific, in this example, the keystone correction section 12 shrinks the rectangular picture illustrated in FIG. 3A in the horizontal direction (x direction) toward the upper side of the picture and expands the picture in the horizontal direction toward the upper side of the picture, as well as shrinks the entire picture in the vertical direction (y direction), as illustrated in FIG. 3B. Therefore, the picture is distorted. In other words, the keystone correction section 12 distorts the input picture (FIG. 3A) into a trapezoidal shape like an inverted trapezoidal shape that is obtained by inverting the trapezoidal shape illustrated in FIG. 2B upside down. Then, the keystone correction section 12 changes luminance information in a region (no picture region) other than the trapezoidal region (picture region A) to a predetermined value (for example, 0 (black)). As a result, the distortion of the picture is offset, and thus the projector 1 is allowed to display a rectangular original picture as illustrated in FIG. 2C on the screen 9.

The keystone correction section 12 performs such arithmetic processing of the keystone correction based on the picture signals supplied from the picture input section 11 to generate picture signals VR1, VG1, and VB1. The picture signals VR1, VG1, and VB1 are signals composed of luminance information of red (R), green (G), and blue (B), respectively. In addition, the keystone correction section 12 also generates a synchronization signal Sync1 synchronized with the picture signals VR1, VG1, and VB1.

The picture processing section 13 performs picture processing based on the picture signals VR1, VG1, and VB1 and the synchronization signal Sync1 that are supplied from the keystone correction section 12. Specifically, the picture processing section 13 has a function of acquiring the picture region A (FIG. 3B) that is changed by the keystone correction section 12 and on which an original picture is displayed, and performing predetermined picture processing based on the picture region A. Then, the picture processing section 13 performs such picture processing on the picture signals VR1, VG1, and VB1 to generate picture signals VR3, VG3, and VB3 and a synchronization signal Sync3 synchronized with the picture signals VR3, VG3, and VB3.

The picture projection section 14 projects a picture onto the screen 9 based on the picture signals VR3, VG3, and VB3 and the synchronization signal Sync3 that are supplied from the picture processing section 13.

### [Picture Processing Section 13]

The picture processing section 13 acquires, from the input picture, the picture region A on which an original picture is displayed, calculates a maximum value, a minimum value, an average, and the like (hereinafter, refer to as a feature amount B) of luminance information in the picture region A, and corrects the picture based on the feature amount. The detail thereof will be described below.

As illustrated in FIG. 1, the picture processing section 13 performs picture processing, based on the picture signals VR1, VG1, and VB1, and the synchronization signal Sync1. In this case, the synchronization signal Sync1 is a collective term of a vertical synchronization signal Vsync1, a horizontal synchronization signal Hsync1, and a clock signal CK1.

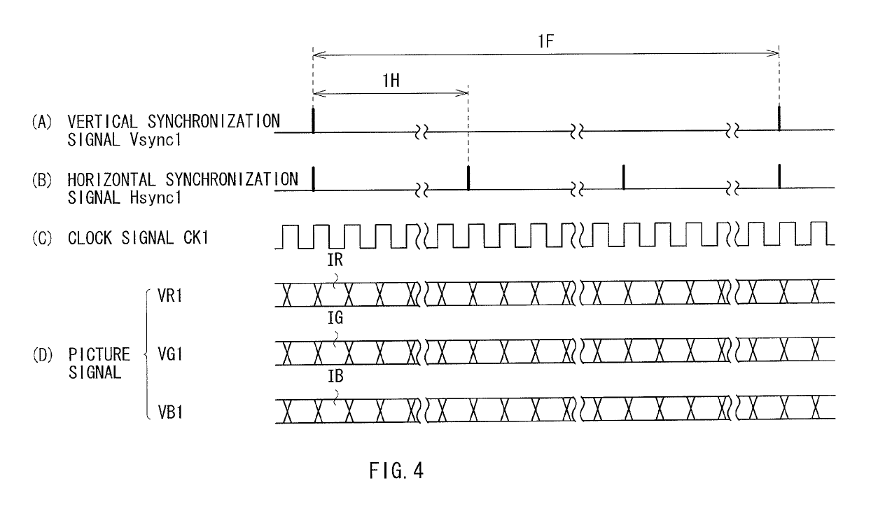

FIG. 4 illustrates an example of waveforms of signals input to the picture processing section 13, where (A) illustrates a waveform of the vertical synchronization signal Vsync1, (B) illustrates a waveform of the horizontal synchronization signal Hsync1, (C) illustrates a waveform of the clock signal CK1, and (D) illustrates waveforms of the picture signals VR1, VG1, and VB1. The picture processing section 13 performs the picture processing based on such signals.

The picture processing section 13 includes a luminance information acquiring section 21, a storage section 22, a picture region acquiring section 30, a control section 23, and a picture correction section 40.

The luminance information acquiring section 21 acquires luminance information IR, IG, and IB, based on the picture signals VR1, VG1, and VB1 and the synchronization signal Sync1. At this time, the luminance information acquiring section 21 acquires the luminance information IR, IG, and IB at pixel coordinates instructed by the control section 23, in a frame picture P supplied from the picture signal V1.

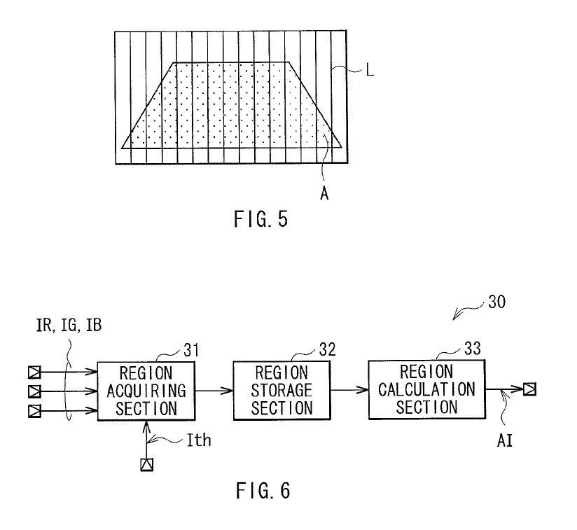

FIG. 5 illustrates an example of the pixel coordinates at which the luminance information acquiring section 21 acquires the luminance information IR, IG, and IB. In this example, the control section 23 controls the luminance information acquiring section 21 to acquire the luminance information IR, IG, and IB at each of pixel coordinates arranged in a shape of lines L that are arranged in parallel in a horizontal direction and extend in a vertical direction. In other words, the luminance information acquiring section 21 acquires the luminance information IR, IG, and IB in a stripe shape from the supplied frame picture P.

At this time, for example, the luminance information acquiring section 21 counts pulses of each signal of the synchronization signal Sync1 to identify the luminance information IR, IG, and IB at the pixel coordinates instructed by the control section 23 from a series of luminance information included in the picture signals VR1, VG1, and VB1, and acquires the identified luminance information IR, IG, and IB.

The luminance information acquiring section 21 supplies the luminance information IR, IG, and IB thus obtained to the picture region acquiring section 30 for each pixel coordinate, namely, for each set of luminance information IR, IG, and IB. Note that this is not limitative, and alternatively, for example, a buffer memory may be provided in the luminance information acquiring section 21 and the luminance information acquiring section 21 may supply the luminance information IR, IG, and IB collectively for each frame picture.

The storage section 22 holds a luminance threshold Ith. For example, the storage section 22 is formed of a non-volatile memory, and is configured to change the luminance threshold Ith through a microcomputer or the like (not illustrated).

The picture region acquiring section 30 acquires the picture region A, based on the luminance information IR, IG, and IB, the luminance threshold Ith, and a control signal that is supplied from the control section 23, and then outputs the acquired picture region A as picture region information AI. At this time, in this example, the picture region acquiring section 30 acquires picture regions A(1) to A(N) for each picture, based on the luminance information IR, IG, and IB acquired from a plurality (N pieces) of frame pictures P(1) to P(N), and determines the picture region A based on the picture regions A(1) to A(N).

FIG. 6 illustrates a configuration example of the picture region acquiring section 30. The picture region acquiring section 30 includes a region acquiring section 31, a region storage section 32, and a region calculation section 33.

The region acquiring section 31 determines luminance information I for each pixel coordinate, based on the luminance information IR, IG, and IB that are acquired in a stripe shape from the frame pictures P(1) to P(N) supplied sequentially. The luminance information I corresponds to a sum of the luminance information IR, IG, and IB. Then, the region acquiring section 31 compares the luminance information I with the luminance threshold Ith for each pixel coordinate to sequentially acquire the picture regions A(1) to A(N). The region storage section 32 holds and accumulates the picture regions A(1) to A(N) that are sequentially supplied from the region acquiring section 31. The region calculation section 33 determines the picture region A based on the picture regions A(1) to A(N) accumulated in the region storage section 32, and outputs the determined picture region A as the picture region information AI. Although not illustrated, these sections operate in conjunction with one another based on the control by the control section 23.

The control section 23 supplies a control signal to each of the luminance information acquiring section 21 and the picture region acquiring section 30 to control these sections. Specifically, the control section 23 has a function to give instructions to the luminance information acquiring section 21 about, for example, the pixel coordinates at which the luminance information IR, IG, and IB are acquired and the number of pixels to be acquired, and to control the luminance information acquiring section 21 and the picture region acquiring section 30 to operate in conjunction with each other. The control section 23 is configured to change the control algorithms from the outside (through a microcomputer not illustrated).

The picture correction section 40 performs picture correction processing on the picture signals VR1, VG1, and VB1, based on the picture region information AI to generate the picture signals VR3, VG3, and VB3. The picture correction section 40 includes a memory 41, a feature amount acquiring section 42, and a correction section 43.

The memory 41 holds the picture region information AI (the picture region A) supplied from the picture region acquiring section 30.

The feature amount acquiring section 42 acquires a maximum value, a minimum value, an average, and the like (the feature amount B) of the luminance information IR, IG, and IB in the picture region A, based on the picture signals VR1, VG1, and VB1, the synchronization signal Sync1, and the picture region A that is stored in the memory 41. Then, the feature amount acquiring section 42 outputs the feature amount B, outputs the picture signals VR1, VG1, and VB1 as the picture signals VR2, VG2, and VB2, and outputs the synchronization signal Sync1 as a synchronization signal Sync2.

The correction section 43 performs picture correction processing such as black expansion and white expansion, based on the picture signals VR2, VG2, and VB2, the synchronization signal Sync2, and the feature amount B to generate the picture signals VR3, VG3, and VB3 and the synchronization signal Sync3.

Here, the luminance information acquiring section 21 and the picture region acquiring section 30 correspond to a specific example of a “region acquiring section” of the disclosure. The picture correction section 40 corresponds to a specific example of an “image processing section” of the disclosure. The picture region A corresponds to a specific example of a “picture region” of the disclosure. The region shape relating to the picture regions A(1) to A(N) corresponds to a specific example of a “tentative region shape” of the disclosure.

### [Operation and Effects]

Subsequently, operation and effects of the projector 1 of the first embodiment will be described.

### (Overall Operation Outline)

First, overall operation outline of the projector 1 is described with reference to FIG. 1. The picture input section 1 receives a picture signal from an external apparatus such as a PC. The keystone correction section 12 performs the arithmetic processing of the keystone correction on the picture signal to generate the picture signals VR1, VG1, and VB1. The picture processing section 13 acquires the picture region A that is changed by the keystone correction section 12 and on which an original picture is displayed, and then performs the picture processing based on the picture region A. Specifically, in the picture processing section 13, according to the control by the control section 23, the luminance information acquiring section 21 acquires the luminance information IR, IG, and IB based on the picture signals VR1, VG1, and VB1, and the picture region acquiring section 30 acquires the picture region A based on the luminance information IR, IG, and IB. The picture correction section 40 acquires the feature amount B of the luminance information IR, IG, and IB in the picture region A, performs the picture correction processing based on the feature amount B, and generates the picture signals VR3, VG3, and VB3 and the synchronization signal Sync3. Then, the picture projection section 14 projects a picture onto the screen 9 based on the picture signals VR3, VG3, and VB3 and the synchronization signal Sync3.

### [Operation Detail of Picture Processing Section 13]

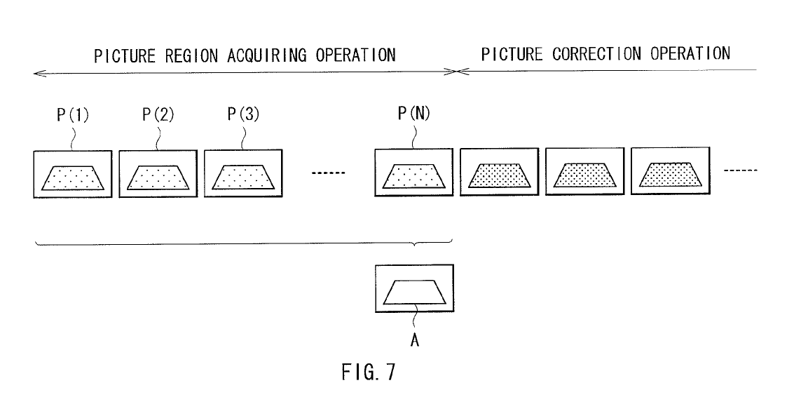

FIG. 7 schematically illustrates an operation of the picture processing section 13. For example, when the projector 1 is connected to an external apparatus such as a PC, and a picture signal starts to be provided, the picture processing section 13 first acquires the picture region A based on first N pieces of frame pictures P(1) to P(N) of a series of frame pictures, according to instructions from a microcomputer or the like (not illustrated) (picture region acquiring operation). Then, after acquiring the picture region A, the picture processing section 13 starts the picture correction processing (picture correction operation) on subsequent series of frame pictures, based on the picture region A.

Note that, in this example, although the picture processing section 13 starts the picture region acquiring operation according to instructions from a microcomputer or the like (not illustrated), this is not limitative. For example, the picture processing section 13 may be configured so as to determine input of the frame pictures to start the picture region acquiring operation.

In addition, in this example, the picture region acquiring operation is started when the projector 1 is connected to an external apparatus. However, this is not limitative, and alternatively, for example, even during use, the picture region acquiring operation may be performed according to demand from a user, or when the relative positional relationship between the projector 1 and the screen 9 is changed, the change is detected and the picture region acquiring operation may be accordingly performed.

Next, the picture region acquiring operation will be described in detail.

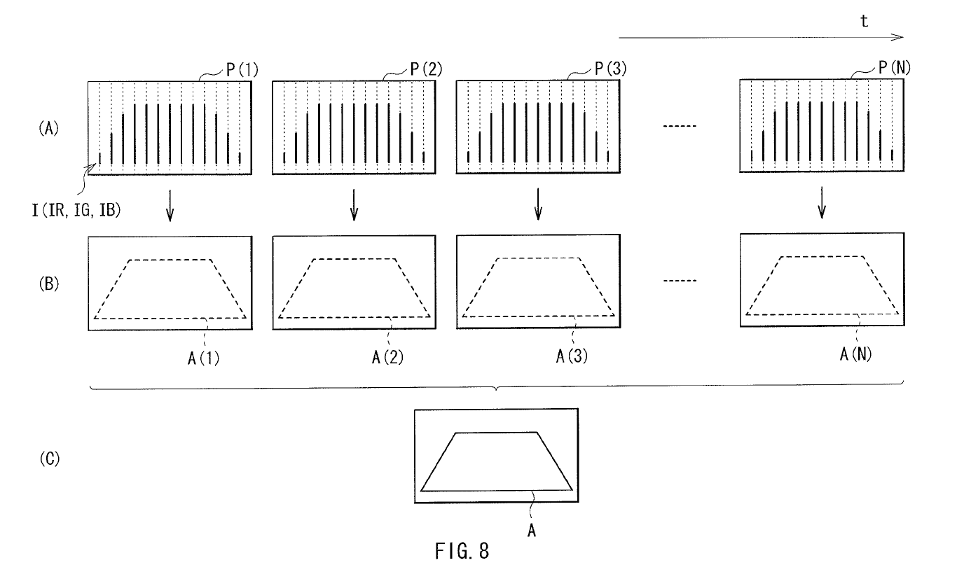

FIG. 8 schematically illustrates an operation example of the luminance information acquiring section 21 and the picture region acquiring section 30, where (A) illustrates an operation of the luminance information acquiring section 21, and (B) and (C) illustrate an operation of the picture region acquiring section 30.

The luminance information acquiring section 21 first acquires the luminance information IR, IG, and IB in a stripe shape based on the supplied frame picture P(1) ((A) of FIG. 8). In (A) of FIG. 8, parts illustrated by dashed lines indicate that the luminance information I determined from the luminance information IR, IG, and IB is 0 (zero), and parts illustrated by solid lines indicate that the luminance information I is not 0 (zero).

Then, the region acquiring section 31 acquires the picture region A(1), based on the luminance information IR, IG, and IB that relate to the frame picture P(1) and are supplied from the luminance information acquiring section 21. Specifically, the region acquiring section 31 first determines the luminance information I corresponding to the sum of the luminance information IR, IG, and IB for each pixel coordinate, based on the luminance information IR, IG, and IB relating to the frame picture P(1). Then, the region acquiring section 31 compares the luminance information I with the luminance threshold Ith for each pixel coordinate to acquire the picture region A(1). At this time, since the luminance information I is 0 (zero) in the outside of the picture region A(1) (no picture region), the region acquiring section 31 is allowed to acquire, as the picture region A(1), a region in which the luminance information I exceeds the luminance threshold Ith properly set. Then, the picture region A(1) acquired by the region acquiring section 31 is stored in the region storage section 32.

As described above, the luminance information acquiring section 21 and the region acquiring section 31 sequentially acquire the picture regions A(1) to A(N) based on the frame pictures P(1) to P(N) sequentially supplied ((A) and (B) of FIG. 8), and store and accumulate the acquired picture regions A(1) to A(N) in the region storage section 32.

Next, the region calculation section 33 determines the picture region A based on the picture regions A(1) to A(N) accumulated in the region storage section 32 ((C) of FIG. 8).

The picture region acquiring section 30 supplies the picture region A thus obtained to the picture correction section 40, as the picture region information AI. Then, the picture correction section 40 uses the picture region A to acquire the maximum value, the minimum value, the average, and the like (the feature amount B) of the luminance information IR, IG, and IB in the picture region A, and then performs the picture correction processing based on the feature amount B.

As described above, the picture processing section 13 acquires the picture region A and performs the picture correction processing based on the acquired picture region A. Therefore, it is possible to acquire the feature amount B in the picture region A with various shapes more precisely and thus to improve image quality. Specifically, in the projector 1, the keystone correction section 12 performs the keystone correction depending on the relative positional relationship between the projector 1 and the screen 9. Therefore, the picture region A in the frame picture subjected to the keystone correction may have various shapes. The picture processing section 13 acquires the shape of the picture region A, determines the feature amount B based on the picture region A, and performs the picture correction processing based on the feature amount B. Accordingly, it is possible to acquire the feature amount B more precisely and thus to improve image quality, irrespective of the relative positional relationship between the projector 1 and the screen 9.

Moreover, the picture processing section 13 acquires the luminance information IR, IG, and IB in a stripe shape from the frame picture P(1) and the like. Therefore, it is possible to reduce the calculation amount for determining the picture region A(1) and the like, as compared with the case where the luminance information IR, IG, and IB is acquired at all of pixel coordinates in the frame picture P(1) and the like.

In addition, the picture processing section 13 determines the picture region A based on the first predetermined number (N pieces) of frame pictures P(1) to P(N) of a series of frame pictures, and performs the picture correction processing on the subsequent frame pictures based on the determined picture region A. Therefore, the picture region A from which the feature amount B is acquired is not frequently changed. As a result, lowering of image quality is suppressed.

Furthermore, the picture processing section 13 determines the picture region A based on the plurality of frame pictures P(1) to P(N). Therefore, for example, even when a moving picture is displayed, it is possible to acquire the picture region A more precisely. Specifically, for example, in the case where the picture region A is determined based on one frame picture P, when the frame picture P is black over the entire screen, etc., the picture region A may not be precisely acquired from the frame picture P. On the other hand, the picture processing section 13 determines the picture region A based on the plurality of frame pictures P(1) to P(N). Therefore, even if a frame picture from which the picture region A is not precisely acquired is included, for example, the picture region A is allowed to be determined from frame pictures other than the frame picture. Consequently, it is possible to acquire the picture region A more precisely.

Moreover, the picture processing section 13 sequentially acquires the picture regions A(1) to A(N) based on the plurality of frame pictures P(1) to P(N) sequentially supplied, and determines the picture region A based on the picture regions A(1) to A(N). Therefore, the configuration of the picture processing section 13 is allowed to be more simplified. Specifically, for example, when the plurality of frame pictures P(1) to P(N) sequentially supplied are all stored temporarily and the picture region A is determined based on the stored frame pictures P(1) to P(N), a storage section with large capacity is necessary for storing the plurality of frame pictures P(1) to P(N), and the configuration is possibly complicated. On the other hand, the picture processing section 13 sequentially acquires the picture regions A(1) to A(N) based on the plurality of frame pictures P(1) to P(N) sequentially supplied and stores the acquired picture regions A(1) to A(N) temporarily. Accordingly, it is possible to reduce storage capacity of the storage section (the region storage section 32), and thus to simplify the configuration.

Subsequently, switching operation from the picture region acquiring operation to the picture correction operation in the picture processing section 13 is described. In this case, the case where the picture region A acquired by the picture region acquiring section 30 is changed from a picture region X to a picture region Y through the picture region acquiring operation is described as an example.

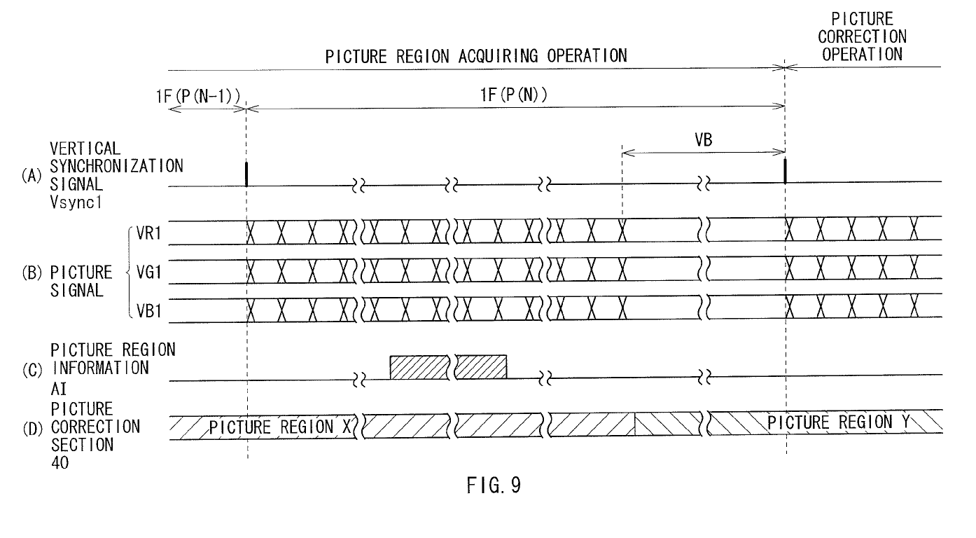

FIG. 9 illustrates an operation example of the picture processing section 13, where (A) illustrates a waveform of the vertical synchronization signal Vsync1, (B) illustrates waveforms of the picture signals VR1, VG1, and VB1, (C) illustrates the picture region information AI, and (D) illustrates an operation of the picture correction section 40. In (C) of FIG. 9, a hatched section indicates that the picture region acquiring section 30 supplies the picture region information AI to the picture correction section 40. In addition, in (D) of FIG. 9, the “picture region X” indicates that the picture correction section 40 performs the picture correction processing based on the picture region X, and the “picture region Y” indicates that the picture correction section 40 performs the picture correction processing based on the picture region Y.

In the picture region acquiring operation, when being supplied with the picture region information AI indicating the picture region Y within a frame period (1F) relating to a last frame picture P(N) ((C) of FIG. 9), the picture correction section 40 stores the picture region information AI in the memory 41. Then, after a vertical blanking period VB is started, the feature amount acquiring section 42 reads new picture region information AI (the picture region Y) stored in the memory 41. Accordingly, the picture processing section 40 is allowed to perform the picture correction processing from a subsequent frame period, based on the picture region Y ((D) of FIG. 9).

As described above, the picture processing section 13 acquires the picture region A and performs the picture correction processing based on the acquired picture region A. Therefore, for example, even in the case where the relative positional relationship between the projector 1 and the screen 9 is changed during use and the shape of the picture region A is changed due to change in calculation of the keystone correction, the feature amount B is obtained depending on the change of the picture region A. Therefore, it is possible to enhance the image quality.

In addition, in the picture processing section 13, even in the case where the picture region A is changed during the frame period, the picture correction processing is performed with use of the prior picture region A until the vertical blanking period VB. Therefore, the processing method is not changed during the picture correction processing to one frame picture, and thus lowering of the image quality is suppressed.

### [Effects]

As described above, in the first embodiment, since the picture region is acquired and the correction processing is performed based on the acquired picture region, it is possible to enhance the image quality.

Moreover, in the first embodiment, the luminance information is acquired in a stripe shape, and the picture region is acquired based on the luminance information. Therefore, it is possible to reduce the calculation amount for acquiring the picture region.

Furthermore, in the first embodiment, the picture regions A(1) to A(N) are sequentially acquired based on the plurality of frame pictures sequentially supplied, and the picture region A is determined based on the acquired picture regions A(1) to A(N). Therefore, it is possible to simplify the configuration.

### [Modification 1-1]

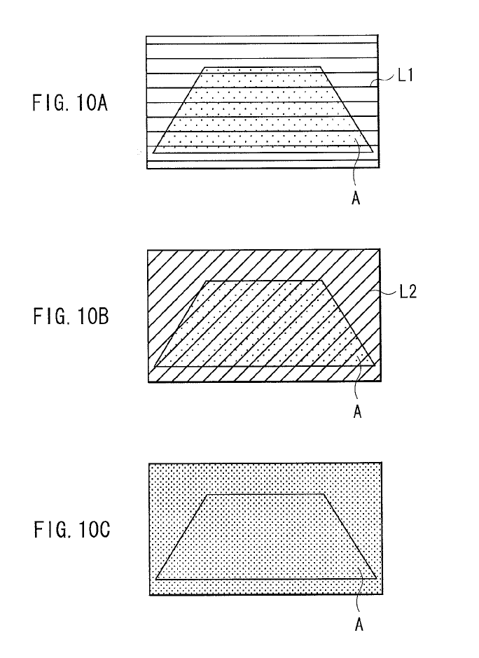

In the first embodiment, the luminance information IR, IG, and IB are acquired at the pixel coordinates arranged in the shape of the lines L extending in the vertical direction. However, this is not limitative, and alternatively, for example, the luminance information IR, IG, and IB may be acquired in pixel coordinates arranged in a shape of lines L1 extending in a horizontal direction as illustrated in FIG. 10A, or may be acquired in pixel coordinates arranged in a shape of lines L2 extending in an oblique direction as illustrated in FIG. 10B. Moreover, the shape is not limited to a stripe formed of the plurality of lines L, and may be one line or a belt having a width. Furthermore, the shape is not limited to a line, and may be a dot as illustrated in FIG. 10C.

### [Modification 1-2]

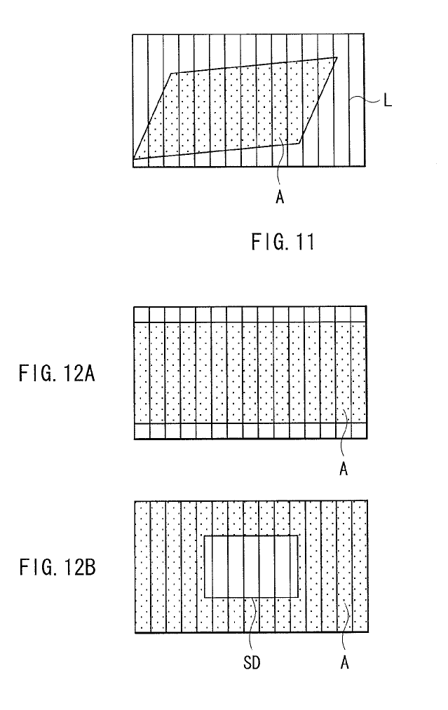

In the first embodiment, as illustrated in FIG. 3B, the case where the picture region A subjected to the keystone correction has a trapezoidal shape has been described as an example. However, this is not limitative, and the picture region A may have other shapes such as a shape illustrated in FIG. 11.

Moreover, in the first embodiment, the projector has been described as an example. However, this is not limitative, and the embodiment of the present disclosure is applicable to all of cases that have the picture region A. Hereinafter, a television will be described as an example.

FIGS. 12A and 12B illustrate application examples of the picture processing section in a television, where FIG. 12A illustrates a case where a movie content is displayed, and FIG. 12B illustrates on-screen display (OSD) is displayed. In the case of a picture having an aspect ratio different from an aspect ratio of a display screen, such as a picture of a movie content, for example, as illustrated in FIG. 12A, black belt regions are generated in a top and a bottom of the display screen. The picture processing section acquires a letter box-shaped picture region A on which an original picture is displayed, other than the black belt regions, and performs the picture correction processing based on the picture region A. In addition, for example, as illustrated in FIG. 12B, in the case where a sub-screen SD by OSD is displayed, the picture processing section acquires the picture region A other than the sub-screen SD, and performs the picture correction processing based on the picture region A.

### [Modification 1-3]

In the first embodiment, the control section 23 is configured as a separate section. However, this is not limitative, and for example, the control section 23 may be included in the picture region acquiring section 30 or the luminance information acquiring section 21.

### [Modification 1-4]

In the first embodiment, although the storage section 22 holds the luminance threshold Ith, the storage section 22 may hold a plurality of luminance thresholds Ith, for example. In such a case, for example, one of the plurality of luminance thresholds may be selected through a microcomputer or the like (not illustrated).

### [Modification 1-5]

In the first embodiment, the picture correction section 40 performs the picture correction processing constantly based on the picture region A. However, this is not limitative. For example, the picture correction section 40 may have two operation modes, namely, an operation mode M1 in which the picture correction processing is performed as in the first embodiment, and an operation mode M2 in which the picture correction processing is not performed at all, and the picture signals VR1, VG1, and VB1 are output as they are as picture signals VR3, VG3, and VB3, respectively. In this case, for example, the picture correction section 40 may be configured such that one of the operation modes M1 and M2 is selected through a microcomputer or the like (not illustrated). In the case where the operation mode is changed from the operation mode M1 to the operation mode M2 and then the operation mode is changed again to the operation mode M1, the picture correction section 40 may perform the picture correction processing based on the picture region A stored in the memory 41, or the picture region acquiring section 30 or others may acquire the picture region A again.

### [Modification 1-6]

In the first embodiment, the luminance information acquiring section 21 acquires the luminance information IR, IG, and IB at the same pixel coordinates between the N pieces of frame pictures P(1) to P(N). However, this is not limitative, and alternatively, for example, the pixel coordinates at which the luminance information IR, IG, and IB are acquired are different from one another between the frame pictures.

### 2. SECOND EMBODIMENT

Next, a projector 2 according to a second embodiment will be described. In the second embodiment, a method of acquiring the picture region A based on the luminance information IR, IG, and IB is different from that in the first embodiment. Other configurations are similar to those in the first embodiment (FIG. 1 and the like). Note that like numerals are used to designate substantially like components of the projector 1 according to the first embodiment, and the description thereof will be appropriately omitted.

As illustrated in FIG. 1, the projector 2 includes a picture processing section 15. The picture processing section 15 includes a picture region acquiring section 50.

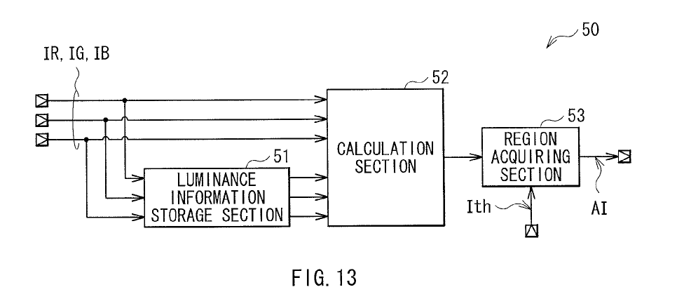

FIG. 13 illustrates a configuration example of the picture region acquiring section 50. The picture region acquiring section 50 includes a luminance information storage section 51, a calculation section 52, and a region acquiring section 53.

The luminance information storage section 51 holds the luminance information IR, IG, and IB acquired in a stripe shape from the frame pictures P(1) to P(N-1) sequentially supplied. The calculation section 52 performs calculation based on the luminance information IR, IG, and IB that relate to the frame pictures P(1) to P(N-1) and are stored in the luminance information storage section 51, and the luminance information IR, IG, and IB that are acquired in a stripe shape from the frame picture P(N) and are supplied from the luminance information acquiring section 21. Specifically, in this example, first, the calculation section 52 determines the luminance information I corresponding to the sum of the luminance information IR, IG, and IB for each pixel coordinate, based on the luminance information IR, IG, and IB. Then, the calculation section 52 performs calculation for determining an average (average luminance information IAV) of the luminance information I that relates to the same pixel coordinates between the frame pictures P(1) to P(N). The region acquiring section 53 compares the average luminance information IAV with the luminance threshold Ith for each pixel coordinate to acquire the picture region A. Although not illustrated, the sections operate in conjunction with one another based on control by the control section 23.

In this case, the average luminance information IAV corresponds to a specific example of “synthesized luminance information” of the disclosure.

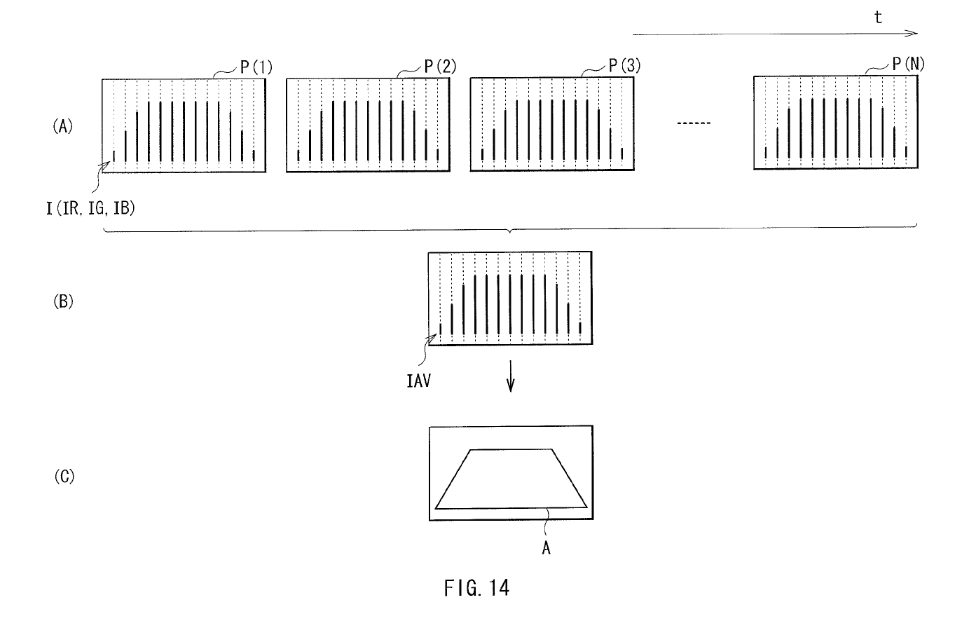

FIG. 14 schematically illustrates an operation example of the luminance information acquiring section 21 and the picture region acquiring section 50, where (A) illustrates an operation of the luminance information acquiring section 21, and (B) and (C) illustrate an operation of the picture region acquiring section 50.

The luminance information acquiring section 21 acquires the luminance information IR, IG, and IB in a stripe shape, based on the supplied frame pictures P(1) to P(N-1) ((A) of FIG. 14). Then, the luminance information storage section 51 holds and accumulates the luminance information IR, IG, and IB.

Subsequently, the luminance information acquiring section 21 acquires the luminance information IR, IG, and IB in a stripe shape, based on the frame picture P(N) subsequently supplied ((A) of FIG. 14).

Thereafter, the calculation section 52 determines the luminance information I corresponding to the sum of the luminance information IR, IG, and IB for each pixel coordinate, based on the luminance information IR, IG, and IB relating to the frame pictures P(1) to P(N-1) stored in the luminance information storage section 51, and the luminance information IR, IG, and IB relating to the frame picture P(N) supplied from the luminance information acquiring section 21. Then, the calculation section 52 calculates the average (the average luminance information IAV) of the luminance information I relating to the same pixel coordinates of the frame pictures P(1) to P(N) ((B) of FIG. 14).

Next, the region acquiring section 53 compares the average luminance information IAV with the luminance threshold Ith for each pixel coordinate to acquire the picture region A ((C) of FIG. 14).

The picture region acquiring section 50 supplies the picture region A thus obtained to the picture correction section 40, as the picture region information AI. Then, the picture correction section 40 uses the picture region A to acquire the maximum value, the minimum value, the average, and the like (the feature amount B) of the luminance information IR, IG, and IB in the picture region A, and then performs the picture correction processing.

As described above, in the second embodiment, the average luminance information (composite luminance information) is determined, and the picture region is determined based on the average luminance information. Therefore, the operation determining the picture region is simplified, and calculation circuits such as the region acquiring section are downsized. Other effects are similar to those in the first embodiment.

### [Modification 2-1]

In the second embodiment, the calculation section 52 performs calculation based on the luminance information IR, IG and IB relating to the N pieces of frame pictures P(1) to P(N). However, this is not limitative, and alternatively, for example, the calculation section 52 may select pictures alternately from the N pieces of frame pictures P(1) to P(N), and may perform calculation based on luminance information IR, IG, and IB relating to the selected pictures.

### [Modification 2-2]

In the second embodiment, although the calculation section 52 performs calculation for determining the average of the luminance information I relating to the same pixel coordinates of the frame pictures P(1) to P(N), this is not limitative. An operation of a picture region acquiring section 50B including a calculation section 52B according to the modification 2-2 will be described in detail below.

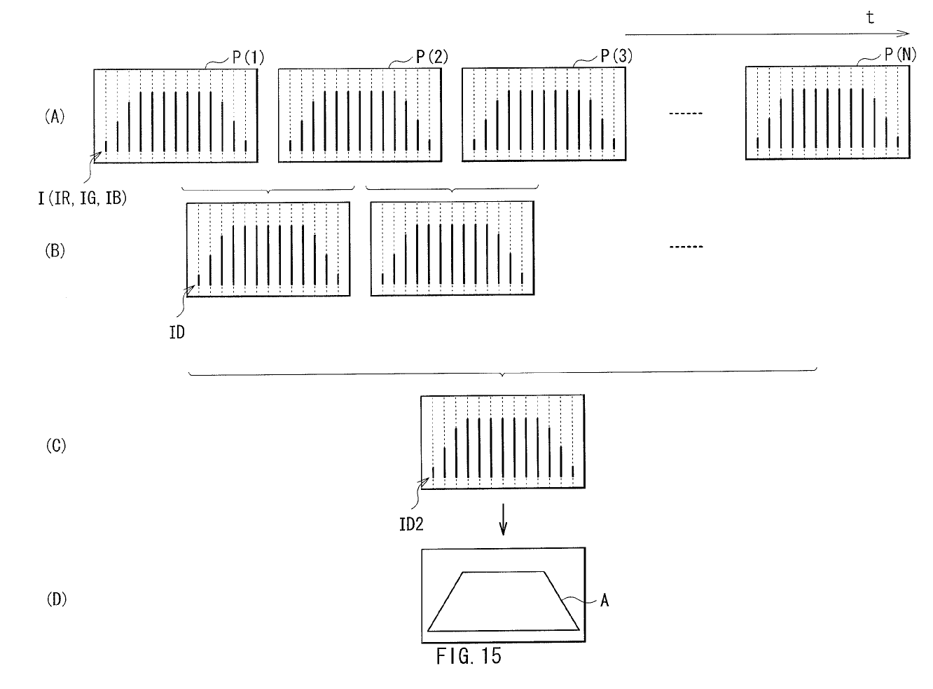

FIG. 15 schematically illustrates an operation example of the luminance information acquiring section 21 and the picture region acquiring section 50B, where (A) illustrates an operation of the luminance information acquiring section 21, and (B) to (D) illustrate an operation of the picture region acquiring section 50B. In the picture region acquiring section 50B, the calculation section 52B determines a difference of luminance information I (difference luminance information ID) between a pair of pictures that are adjacent to each other on a time axis, of the frame pictures P(1) to P(N-1), for each pixel coordinate ((B) of FIG. 15). Next, the calculation section 52B determines a sum of the difference luminance information ID (difference luminance information ID2) for each pixel coordinate ((C) of FIG. 15). Then, the region acquiring section 53 compares the difference luminance information ID2 with the luminance threshold Ith for each pixel coordinate to acquire the picture region A ((D) of FIG. 15).

For example, when a moving picture is displayed, the difference luminance information ID and ID2 each have a value other than 0 (zero) in the picture region A. On the other hand, in a region (no picture region) other than the picture region A, since the luminance information I maintains the value of 0 (zero), the difference luminance information ID and ID2 are also 0 (zero). Accordingly, the region acquiring section 53 compares the difference luminance information ID2 with the luminance threshold Ith for each pixel coordinate to acquire the picture region A.

### 3. THIRD EMBODIMENT

Next, a projector 3 according to a third embodiment will be described. In the third embodiment, the pixel coordinates at which the luminance information IR, IG, and IB are acquired change between frame pictures. Other configurations are similar to those in the first embodiment and the like (FIG. 1 and others). Note that like numerals are used to designate substantially like components of the projector 1 according to the first embodiment, and the description thereof will be appropriately omitted.

As illustrated in FIG. 1, the projector 3 includes a picture processing section 16. The picture processing section 16 includes a control section 29 and a picture region acquiring section 60.

The control section 29 supplies a control signal to each of the luminance information acquiring section 21 and the picture region acquiring section 60 to control these sections, similarly to the control section 23 according to the first embodiment and the like. At this time, the control section 29 controls the luminance information acquiring section 21 such that the pixel coordinates at which the luminance information IR, IG, and IB are acquired are changed between frame pictures.

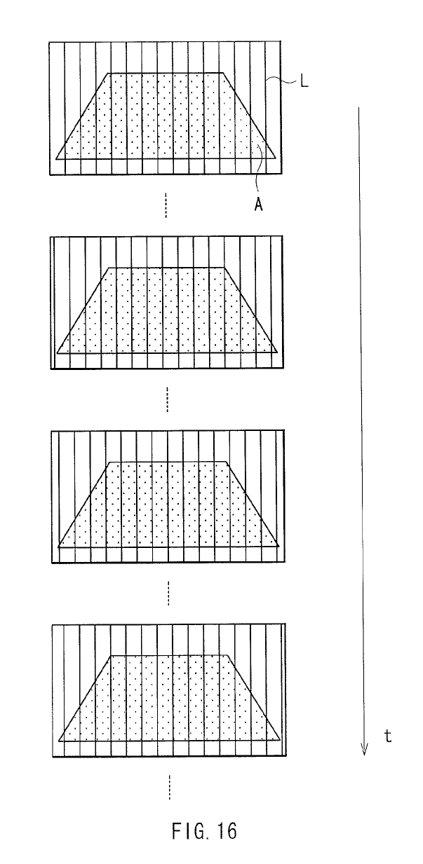

FIG. 16 illustrates an example of the pixel coordinates at which the luminance information acquiring section 21 acquires the luminance information I. In this example, the control section 29 changes the pixel coordinates at which the luminance information acquiring section 21 acquires the luminance information IR, IG, and IB, by shifting stripe formed of a plurality of lines L by one pixel in the horizontal direction for each frame picture of the frame pictures P(1) to P(N).

The picture region acquiring section 60 acquires the picture region A, based on the luminance information IR, IG, and IB that are acquired by the luminance information acquiring section 21 according to an instruction by the control section 29.

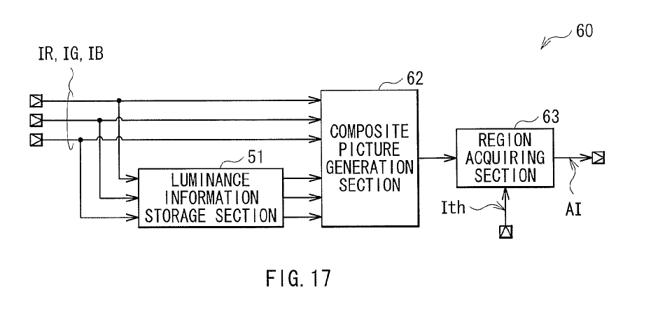

FIG. 17 illustrates a configuration example of the picture region acquiring section 60. The picture region acquiring section 60 includes the luminance information storage section 51, a composite picture generation section 62, and a region acquiring section 63.

The composite picture generation section 62 composes the luminance information IR, IG, and IB relating to the frame pictures P(1) to P(N-1) stored in the luminance information storage section 51 and the luminance information IR, IG, and IB that are acquired in a stripe shape from the frame picture P(N) supplied from the luminance information acquiring section 21 to generate one composite frame picture PS. The region acquiring section 63 determines the luminance information I corresponding to the sum of the luminance information IR, IG, and IB for each pixel coordinate, based on the luminance information IR, IG, and IB of the composite frame picture PS, and compares the luminance information I with the luminance threshold Ith for each pixel coordinate to acquire the picture region A. Although not illustrated, these sections operate in conjunction with one another based on the control by the control section 29.

In this case, the composite frame picture PS corresponds to a specific example of “composite picture” of the disclosure.

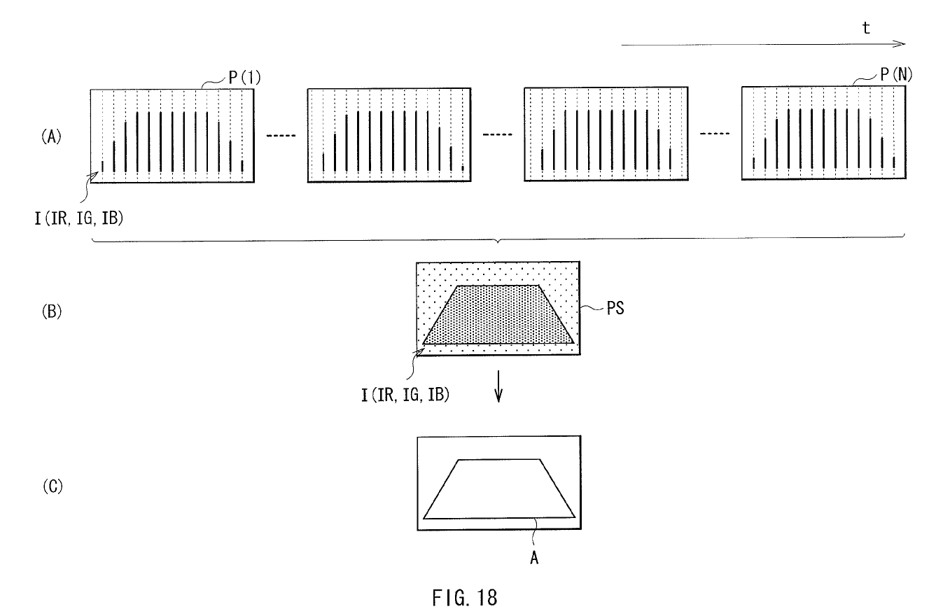

FIG. 18 schematically illustrates an operation example of the luminance information acquiring section 21 and the picture region acquiring section 60, where (A) illustrates an operation of the luminance information acquiring section 21, and (B) and (C) illustrate an operation of the picture region acquiring section 60.

The composite picture generation section 62 generates the composite frame picture PS, based on the luminance information I relating to the frame pictures P(1) to P(N-1) stored in the luminance information storage section 51 and the luminance information I relating to the frame picture P(N) supplied from the luminance information acquiring section 21 ((B) of FIG. 18). Specifically, the luminance information acquiring section 21 acquires the luminance information IR, IG, and IB while shifting the stripe formed of the plurality of lines L extending in the vertical direction, by one pixel in the horizontal direction for each frame picture of the frame pictures P(1) to P(N). Therefore, the composite picture generation section 62 generates the composite frame picture PS with the same number of pixels as that of the frame picture P(1).

Next, the region acquiring section 53 determines the luminance information I corresponding to the sum of the luminance information IR, IG, and IB for each pixel coordinate, based on the luminance information IR, IG, and IB of the composite frame picture PS. Then, the region acquiring section 53 compares the luminance information I with the luminance threshold Ith for each pixel coordinate to acquire the picture region A ((C) of FIG. 18).

The picture region acquiring section 60 supplies the picture region A thus obtained to the picture correction section 40, as the picture region information AI. Then, the picture correction section 40 uses the picture region A to acquire the maximum value, the minimum value, the average, and the like (the feature amount B) of the luminance information IR, IG, and IB in the picture region A, and then performs the picture correction processing.

As described above, in the third embodiment, the pixel coordinates at which the luminance information is acquired are changed between the frame pictures. Therefore, even if the shape of the picture region is complicated, the shape of the picture region is acquired more precisely and thus the feature amount is acquired more precisely. As a result, the image quality is enhanced. Other effects are similar to those in the first embodiment.

### 4. FOURTH EMBODIMENT

Subsequently, a projector 4 according to a fourth embodiment will be described. In the fourth embodiment, the pixel coordinates at which the luminance information is acquired change between frame pictures, and the picture region A is acquired focusing on no picture region. Other configurations are similar to those in the third embodiment and the like (FIG. 1, etc.). Note that like numerals are used to designate substantially like components of the projector 3 according to the third embodiment, and the description thereof will be appropriately omitted.

As illustrated in FIG. 1, the projector 4 includes a picture processing section 17. The picture processing section 17 includes the control section 29 and a picture region acquiring section 70.

The picture region acquiring section 70 acquires the picture region A while focusing on no picture region, based on the luminance information IR, IG, and IB that are acquired by the luminance information acquiring section 21 according to instructions of the control section 29.

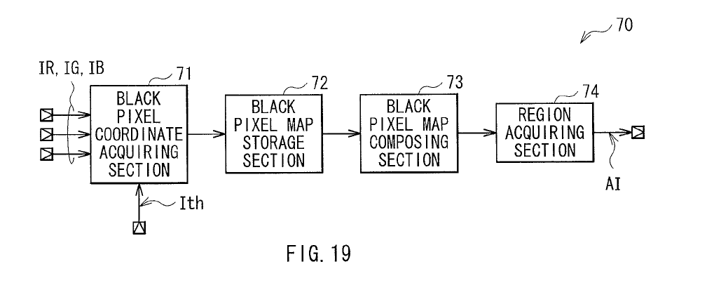

FIG. 19 illustrates a configuration example of the picture region acquiring section 70. The picture region acquiring section 70 includes a black pixel coordinate acquiring section 71, a black pixel map storage section 72, a black pixel map composing section 73, and a region acquiring section 74.

The black pixel coordinate acquiring section 71 acquires pixel coordinates (black pixel coordinates) relating to no picture region, based on the luminance information IR, IG, and IB that are acquired in a stripe shape from the frame pictures P(1) to P(N) sequentially supplied. Specifically, the black pixel coordinate acquiring section 71 determines the luminance information I corresponding to the sum of the luminance information IR, IG, and IB for each pixel coordinate, based on the luminance information IR, IG, and IB. Then, the black pixel coordinate acquiring section 71 compares the luminance information I with the luminance threshold Ith to acquire pixel coordinates (the black pixel coordinates) at which the luminance information I is lower than the luminance threshold Ith.

The black pixel map storage section 72 holds and accumulates the position of the black pixel coordinates for each frame picture as map data (black pixel maps MAP(1) to MAP(N)), based on the black pixel coordinates relating to the frame pictures P(1) to P(N), supplied from the black pixel coordinate acquiring section 71. In this case, in the black pixel maps MAP(1) to MAP(N), for example, a part corresponding to a black pixel is indicated by “1” and other parts are indicated by “0”.

The black pixel map composing section 73 composes the black pixel maps MAP(1) to MAP(N) stored in the black pixel map storage section 72 to generate a black pixel map MAP. The region acquiring section 74 acquires the picture region A based on the black pixel map MAP.

Although not illustrated, these sections operate in conjunction with one another based on the control by the control section 29.

In this case, the black pixel maps MAP(1) to MAP(N) correspond to a specific example of “partial map” of the disclosure. The black pixel map MAP corresponds to a specific example of “composite map” of the disclosure.

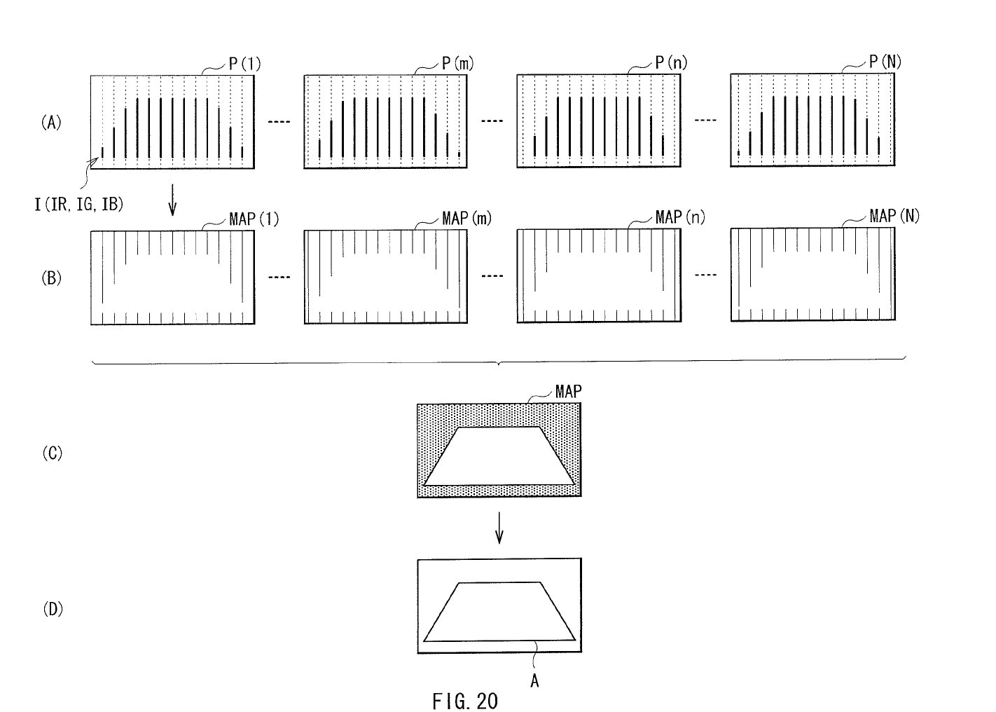

FIG. 20 schematically illustrates an operation example of the luminance information acquiring section 21 and the picture region acquiring section 70, where (A) illustrates an operation of the luminance information acquiring section 21, and (B) and (C) illustrate an operation of the picture region acquiring section 70.

The black pixel coordinate acquiring section 71 determines the luminance information I corresponding to the sum of the luminance information IR, IG, and IB for each pixel coordinate, based on the luminance information IR, IG, and IB that are acquired in a stripe shape from the frame pictures P(1) to P(N) sequentially supplied, and compares the luminance information I with the luminance threshold Ith to acquire pixel coordinates (the black pixel coordinates) at which the luminance information I is lower than the luminance threshold Ith. Then, the black pixel map storage section 72 holds and accumulates the black pixel coordinates as map data (black pixel maps MAP(1) to MAP(N)) for each frame picture ((B) of FIG. 20).

Next, the black pixel map composing section 73 composes the black pixel maps MAP(1) to MAP(N) stored in the black pixel map storage section 72 to generate the black pixel map MAP ((C) of FIG. 20). Specifically, the luminance information acquiring section 21 acquires the luminance information IR, IG, and IB while shifting the stripe formed of the plurality of lines L, by one pixel in the horizontal direction for each frame picture of the frame pictures P(1) to P(N). Therefore, the black pixel map composing section 73 generates the black pixel map MAP with the same number of pixels as that of the frame picture P(1) and the like.

Then, the region acquiring section 74 acquires the picture region A based on the black pixel map MAP ((D) of FIG. 20).

The picture region acquiring section 70 supplies the picture region A thus obtained to the picture correction section 40 as the picture region information AI. Then, the picture correction section 40 uses the picture region A to acquire the maximum value, the minimum value, the average, and the like (the feature amount B) of the luminance information IR, IG, and IB in the picture region A, and then performs the picture correction processing.

The picture processing section 17 generates the black pixel maps MAP(1) to MAP(N) from the frame pictures P(1) to P(N) sequentially supplied, composes the black pixel maps MAP(1) to MAP(N) to generate the black pixel map MAP, and acquires the picture region A based on the black pixel map MAP. Therefore, the configuration is simplified. Specifically, in the above-described third embodiment, since the luminance information storage section 51 holds the luminance information IR, IG, and IB, a large storage capacity may be necessary. On the other hand, since the picture processing section 17 holds the black pixel maps MAP(1) to MAP(N), the storage capacity of the storage section (the black pixel map storage section 72) is reduced and the configuration is more simplified.

As described above, in the fourth embodiment, the picture region is acquired based on the black pixel map. Therefore, the configuration is simplified. Other effects are similar to those in the third embodiment.

### 5. APPLICATION EXAMPLES

Hereinbefore, although the picture processing section has been described by taking a projector as an example, this is not limitative. Application examples of the picture processing section described in the above-described embodiments and the modifications will be described below.

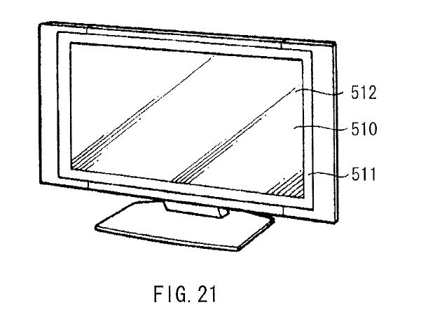

FIG. 21 illustrates an appearance of a television to which the picture processing section according to any of the embodiments and the modifications is applied. The television includes, for example, a picture display screen section 510 including a front panel 511 and a filter glass 512. The television includes the picture processing section according to any of the embodiments and the modifications.

The picture processing section according to any of the embodiments and the modifications is applicable to electronic units in various fields, for example, a digital camera, a notebook personal computer, a mobile terminal device such as a mobile phone, a portable game machine, and a video camera, in addition to such a television. In other words, the picture processing section according to any of the embodiments and the modifications is applicable to electronic units which display a picture, in various fields.

Hereinbefore, although the technology has been described with reference to the embodiments, the modifications thereof, the specific application example thereof, and the application example to the electronic units, the technology is not limited thereto, and various modifications may be made.

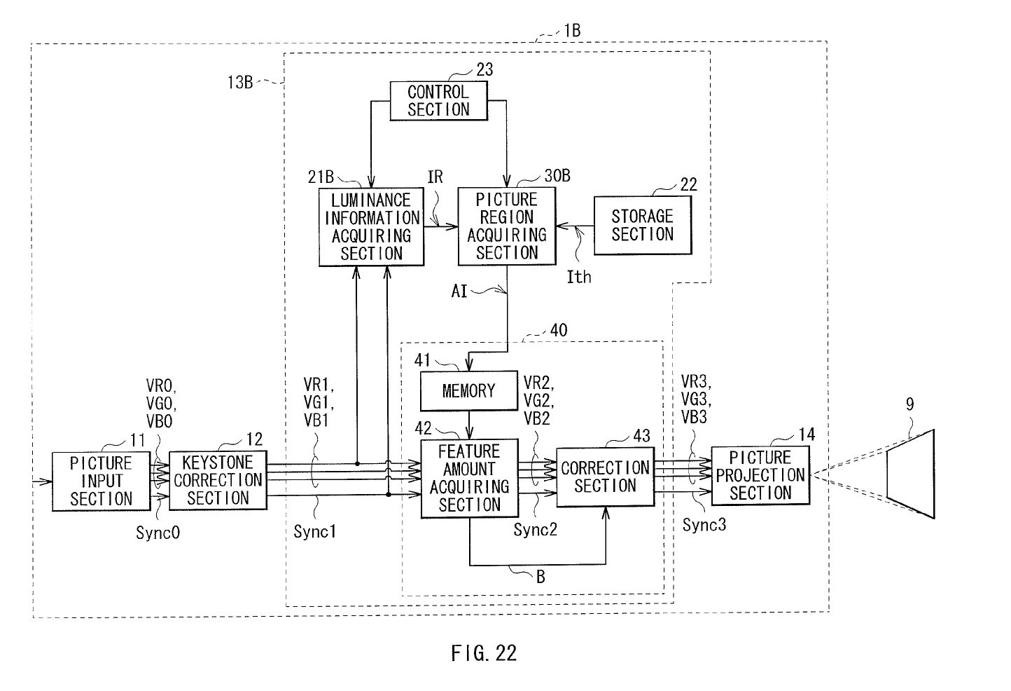

For example, in the embodiments and the like, the luminance information acquiring section 21 acquires the luminance information IR, IG, and IB from the picture signals VR1, VG1, and VB1, and the picture region acquiring section 30 acquires the picture region A based on the luminance information IR, IG, and IB. However, this is not limitative, and alternatively, for example, as illustrated in FIG. 22, a luminance information acquiring section 21B may acquire luminance information from one (in this example, the picture signal VR1) of the picture signals VR1, VG1, and VB1, and the picture region acquiring section 30 may acquire the picture region A based on the luminance information. Moreover, for example, the luminance information acquiring section may be configured to select a picture signal from which luminance information is acquired.

Furthermore, for example, in the embodiments and the like, the luminance information acquiring section 21 acquires the luminance information IR, IG, and IB in a stripe shape. However, this is not limitative, and alternatively, the luminance information acquiring section 21 may acquire all of luminance information IR, IG, and IB of an input picture. In addition, in the embodiments, the luminance information IR, IG, and IB are acquired from the plurality (N pieces) of frame pictures, and the picture region A is acquired based on the acquired luminance information IR, IG, and IB. However, this is not limitative, and alternatively, for example, the luminance information IR, IG, and IB are acquired from only one frame picture, and the picture region A is acquired based on the acquired luminance information IR, IG, and IB.

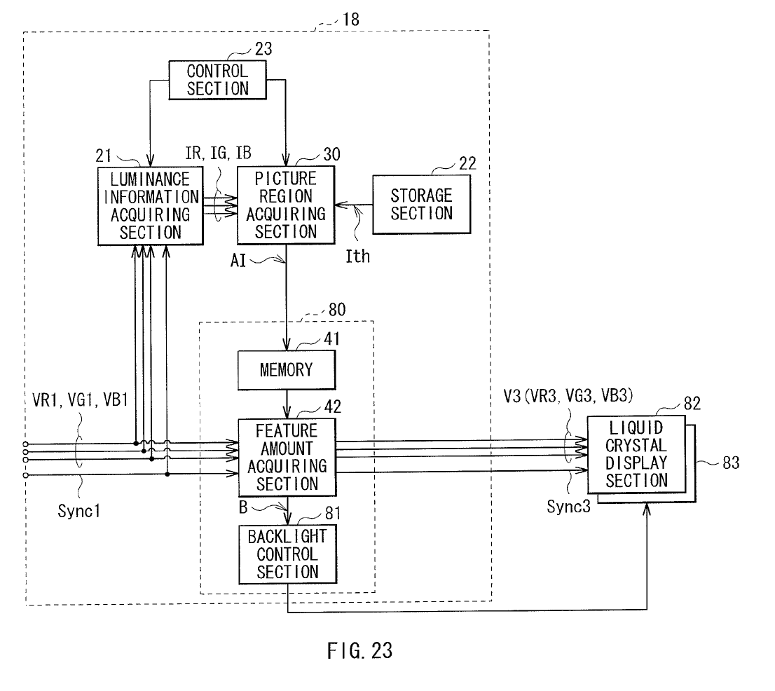

Moreover, for example, in the embodiments and the like, the picture processing section 13 and the like perform the picture correction processing based on the feature amount B. However, this is not limitative, and alternatively, the picture processing section 13 and the like may control emission luminance of a backlight 83 of a liquid crystal display section 82, based on the feature amount B, as illustrated in FIG. 23.

Note that the technology may be configured as follows.

(1) An image processing unit including:

a region acquiring section determining a region shape of a picture region, based on a predetermined number of frame pictures of a series of frame pictures; and

an image processing section performing predetermined image processing based on the region shape.

(2) The image processing unit according to (1), wherein the region acquiring section samples luminance information at a plurality of pixel coordinates for each of the predetermined number of frame pictures, and determines the region shape based on the luminance information.

(3) The image processing unit according to (2), wherein the plurality of pixel coordinates is coordinates of a part of all pixels, the all pixels configuring each frame picture.

(4) The image processing unit according to (3), wherein the plurality of pixel coordinates is fixed in the predetermined number of frame pictures.

(5) The image processing unit according to (3), wherein the plurality of pixel coordinates in one of the frame pictures is different from the plurality of pixel coordinates in one of the remaining frame pictures.

(6) The image processing unit according to any one of (3) to (5), wherein the region acquiring section determines a tentative region shape of a picture region, based on each of the predetermined number of frame pictures, and determines the region shape based on a plurality of the tentative region shapes.

(7) The image processing unit according to (4), wherein the region acquiring section determines synthesized luminance information from the luminance information of the predetermined number of frame pictures for each of the plurality of pixel coordinates, and determines the region shape based on the synthesized luminance information.

(8) The image processing unit according to (3), wherein the plurality of pixel coordinates is different from one another among the predetermined number of frame pictures.

(9) The image processing unit according to (8), wherein the region acquiring section generates a composite picture, based on the luminance information of the predetermined number of frame pictures, and determines the region shape based on the composite picture.

(10) The image processing unit according to (8), wherein the region acquiring section determines a partial map indicating pixel coordinates at which the luminance information is at black level, based on each of the predetermined number of frame pictures, generates a composite map based on the partial maps determined from the predetermined number of frame pictures, and determines the region shape based on the composite map.

(11) The image processing unit according to any one of (3) to (10), wherein the plurality of pixel coordinates configures one or a plurality of lines.

(12) The image processing unit according to any one of (2) to (11), wherein the region acquiring section stops operation after determining the region shape from the predetermined number of frame pictures.

(13) The image processing unit according to (1), wherein the region acquiring section samples luminance information at a plurality of pixel coordinates for one of the series of frame pictures, and determines the region shape based on the luminance information.

(14) The image processing unit according to (2) or (13), wherein the plurality of pixel coordinates is coordinates of all pixels configuring each of the frame pictures.

(15) The image processing unit according to any one of (1) to (14), wherein the image processing section performs, based on luminance information in the picture region of each of the frame pictures, image processing on the frame picture.

(16) An image processing method including:

determining a region shape of a picture region, based on a predetermined number of frame pictures of a series of frame pictures; and performing predetermined image processing based on the region shape.

(17) A display including:

a region acquiring section determining a region shape of a picture region, based on a predetermined number of frame pictures of a series of frame pictures;

an image processing section performing predetermined image processing based on the region shape; and

a display section displaying a picture subjected to the predetermined image processing.

(18) An electronic apparatus provided with an image processing unit and a control section controlling operation by using the image processing unit, the image processing unit including:

a region acquiring section determines a region shape of a picture region, based on a predetermined number of frame pictures of a series of frame pictures; and

an image processing section performing predetermined image processing based on the region shape.

The present application contains subject matter related to that disclosed in Japanese Priority Patent Application JP 2012-085529 filed in the Japan Patent Office on Apr. 4, 2012, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. An image processing unit comprising:
a region acquiring section determining a region shape of a picture region, based on a predetermined number of frame pictures of a series of frame pictures; and
an image processing section performing predetermined image processing based on the region shape.

2. The image processing unit according to claim 1, wherein the region acquiring section samples luminance information at a plurality of pixel coordinates for each of the predetermined number of frame pictures, and determines the region shape based on the luminance information.

3. The image processing unit according to claim 2, wherein the plurality of pixel coordinates is coordinates of a part of all pixels, the all pixels configuring each frame picture.

4. The image processing unit according to claim 3, wherein the plurality of pixel coordinates is fixed in the predetermined number of frame pictures.

5. The image processing unit according to claim 3, wherein the plurality of pixel coordinates in one of the frame pictures is different from the plurality of pixel coordinates in one of the remaining frame pictures.

6. The image processing unit according to claim 3, wherein the region acquiring section determines a tentative region shape of a picture region, based on each of the predetermined number of frame pictures, and determines the region shape based on a plurality of the tentative region shapes.

7. The image processing unit according to claim 4, wherein the region acquiring section determines synthesized luminance information from the luminance information of the predetermined number of frame pictures for each of the plurality of pixel coordinates, and determines the region shape based on the synthesized luminance information.

8. The image processing unit according to claim 3, wherein the plurality of pixel coordinates is different from one another among the predetermined number of frame pictures.

9. The image processing unit according to claim 8, wherein the region acquiring section generates a composite picture, based on the luminance information of the predetermined number of frame pictures, and determines the region shape based on the composite picture.

10. The image processing unit according to claim 8, wherein the region acquiring section determines a partial map indicating pixel coordinates at which the luminance information is at black level, based on each of the predetermined number of frame pictures, generates a composite map based on the partial maps determined from the predetermined number of frame pictures, and determines the region shape based on the composite map.

11. The image processing unit according to claim 3, wherein the plurality of pixel coordinates configures one or a plurality of lines.

12. The image processing unit according to claim 2, wherein the region acquiring section stops operation after determining the region shape from the predetermined number of frame pictures.

13. The image processing unit according to claim 1, wherein the region acquiring section samples luminance information at a plurality of pixel coordinates for one of the series of frame pictures, and determines the region shape based on the luminance information.

14. The image processing unit according to claim 2, wherein the plurality of pixel coordinates is coordinates of all pixels configuring each of the frame pictures.

15. The image processing unit according to claim 1, wherein the image processing section performs, based on luminance information in the picture region of each of the frame pictures, image processing on the frame picture.

16. An image processing method comprising:
determining a region shape of a picture region, based on a predetermined number of frame pictures of a series of frame pictures; and
performing predetermined image processing based on the region shape.

17. A display comprising:
a region acquiring section determining a region shape of a picture region, based on a predetermined number of frame pictures of a series of frame pictures;
an image processing section performing predetermined image processing based on the region shape; and
a display section displaying a picture subjected to the predetermined image processing.

18. An electronic apparatus provided with an image processing unit and a control section controlling operation by using the image processing unit, the image processing unit comprising:
a region acquiring section determines a region shape of a picture region, based on a predetermined number of frame pictures of a series of frame pictures; and
an image processing section performing predetermined image processing based on the region shape.
